(19) United States
(12) Patent Application Publication
(10) Pub. No.: US 2016/0154492 A1
(43) Pub. Date: Jun. 2, 2016

(54) TOUCH SCREEN PANEL, TOUCH SCREEN AND DISPLAY DEVICE

(71) Applicants: Boe Technology Group Co., Ltd., Beijing (CN); Hefei Xinsheng Optoelectronics Technology Co., Ltd., Anhui (CN)

(72) Inventors: Hongqiang Luo, Beijing (CN); Ming Hu, Beijing (CN); Taofeng Xie, Beijing (CN)

(21) Appl. No.: 14/741,806

(22) Filed: Jun. 17, 2015

(30) Foreign Application Priority Data
Dec. 2, 2014 (CN) 201410722636.7

(51) Int. Cl. G06F 3/041

(52) U.S. Cl. CPC G06F 3/041

(57) ABSTRACT

The present invention relates to the technical field of display device production, and discloses a touch screen panel, a touch screen and a display device. The touch screen panel comprises a substrate and a light blocking frame arranged on the substrate and located at the non-display area of the touch screen, wherein the light blocking frame comprises at least two layers of step structure convenient for metal wire climbing. In the above technical solution, by using the light blocking frame with the step structure, the climbing height of the metal wire is reduced as the height of the step, which reduces the climbing difficulty of the metal wire, avoids the metal wire from being broken due to over high of the light blocking frame, and improves security of the metal wire setting. Meanwhile, the above step structure is used such that the light blocking frame can be fabricated using white photoresist material. Thus, white products of OGS are realized.

The present application claims the benefit of Chinese Patent Application No. 201410722636.7, filed Dec. 2, 2014, the entire disclosures of which are incorporated herein by reference.

### FIELD OF THE INVENTION

The present invention relates to the technical field of display device production, particularly to a touch screen panel, a touch screen and a display device.

### BACKGROUND OF THE INVENTION

The traditionally used capacitive touch screen is generally a structure formed by jointing a layer of cover board glass with a layer of touch control glass through optical adhesive (OCA), i.e., GG (Glass-Glass) structure, however, in the competitive touch control market, the touch screen is required to be light, thin, low cost gradually, the GG structure has already been incapable of meeting these requirements, and has been replaced by touch control structures such as GF (Glass-Film), GFF (Glass-Film-Film), OGS (One Glass Solution) gradually.

In the current market, touch screens of OGS structure have encountered a problem in appearance relative to the touch screens of GG, GF, GFF structures. Conventional GG, GF, GFF structures use black ink or white ink as the frame material of the cover board, black touch screens and white touch screens can be produced. The OGS uses photoresist frame material, however, the technology of the OGS touch control product applying white photoresist in the current market is still not well developed, only black OGS touch control products can be seen in the market, the white OGS touch control product has not come into the market yet.

### SUMMARY OF THE INVENTION

The embodiments of the present invention provide a touch screen panel, a touch screen and a display device, for reducing the climbing difficulty of the metal wires in the touch screen panel, thereby reducing the production difficulty of the touch screen panel, and increasing yield of the production of the touch screen panel.

An embodiment of the present invention provides a touch screen panel, the touch screen panel comprises a substrate and a light blocking frame arranged on the substrate and located in the non-display area of the touch screen, wherein the light blocking frame comprises at least two layers of step structure convenient for metal wire climbing.

In the technical solution mentioned above, the climbing height of the metal wire is reduced as the height of the step by using the light blocking frame with the step structure, which reduces the climbing difficulty of the metal wire, avoids the metal wire from being broken due to over high of the light blocking frame, and improves security of the metal wire setting. Meanwhile, the above step structure is used such that the light blocking frame can be fabricated using white photoresist material. Thus, a white touch screen panel product of OGS is realized.

In an embodiment, the light blocking frame of the touch screen panel comprises at least one white photoresist layer and a black photoresist layer arranged successively along a direction away from the substrate, and the widths of the at least one white photoresist layer and the black photoresist layer decrease successively along the direction away from the substrate so as to form the step structure. The step structure is formed through the white photoresist layers and the black photoresist layer.

In another embodiment, the light blocking frame comprises three white photoresist layers, and adjacent white photoresist layers decrease gradually in width along the direction away from the substrate.

In an embodiment, the thickness of each of the white photoresist layers is between 4-5 μm, the amount by which each white photoresist layer decreases gradually in width compared with its adjacent white photoresist layer is between 60-100 μm.

Further, in an embodiment, the thickness of each of the white photoresist layers is 5 μm, the amount by which each white photoresist layer decreases gradually in width compared with its adjacent white photoresist layer is 80 μm.

In an embodiment, the white photoresist layers are photoresist layers is formed by white ink.

In an embodiment, the thickness of the black photoresist layer is between 1˜2 μm, the amount by which the width of the black photoresist layer decreases compared with the width of its adjacent white photoresist layer is between 20˜40 μm. In this way, the light blocking effect of the light blocking frame can be improved.

In an embodiment, the thickness of the black photoresist layer is 1 μm, the amount by which the width of the black photoresist layer decreases compared with the width of its adjacent white photoresist layer is 20 μm.

The embodiment of the present invention further provides a touch screen, the touch screen can comprise any of the touch screen panels as stated above.

In the above technical solutions, the climbing height of the metal wire is reduced as the height of the step by using the light blocking frame with the step structure, which reduces the climbing difficulty of the metal wire, avoids the metal wire from being broken due to over high of the light blocking frame, and improves security of the metal wire setting. Meanwhile, the above step structure is used such that the light blocking frame can be fabricated using white photoresist material. Thus, a white touch screen product of OGS is realized.

The present invention further provides a display device, the display device may comprise the touch screens mentioned above.

In the above technical solution, the climbing height of the metal wire is reduced as the height of the step by using the light blocking frame with the step structure, which reduces the climbing difficulty of the metal wire, avoids the metal wire from being broken due to over high of the light blocking frame, and improves security of the metal wire setting. Meanwhile, the above step structure is used such that the light blocking frame can be fabricated using white photoresist material. Thus, a white display device product of OGS is realized.

### BRIEF DESCRIPTION OF THE DRAWINGS

FIG. 1 is a plan view of a touch screen panel provided by an embodiment of the present invention;

FIG. 2 is a sectional view of the touch screen panel taken along line A-A in FIG. 1.

### REFERENCE SIGNS

1—substrate 2—light blocking frame 21—first white photoresist layer 22—second white photoresist layer 23—third white photoresist layer 24—black photoresist layer

### DETAILED DESCRIPTION OF THE INVENTION

In order to reduce the climbing difficulty of the metal wires in the touch screen panel, thereby reducing the production difficulty of the touch screen panel, and increasing yield of the production of the touch screen panel, the embodiments of the present invention provide a touch screen panel, a touch screen and a display device. In the technical solution of the present invention, by using the step structure convenient for metal wire climbing formed in the light blocking frame, white photoresist layers can be used to form the light blocking frame in the touch screen panel. In order to make the objects, the technical solutions and the advantages of the present invention clearer, nonrestrictive embodiments are taken as examples to make further detailed explanations to the present invention in the following.

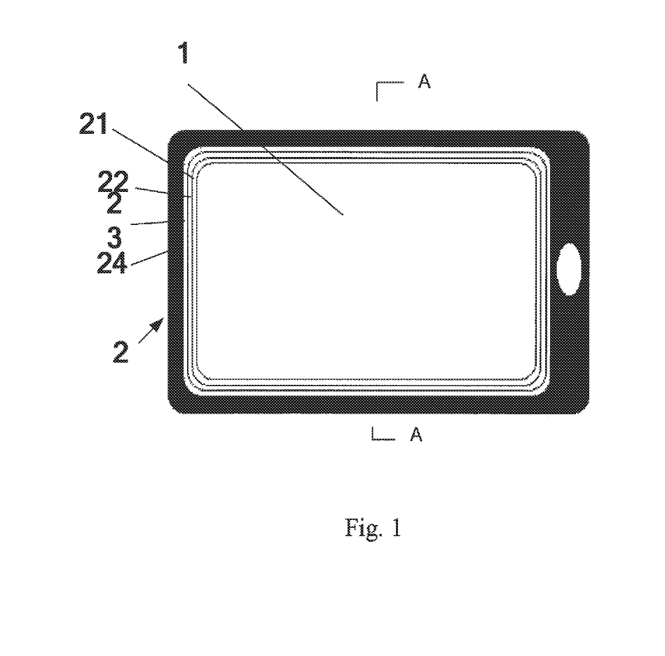

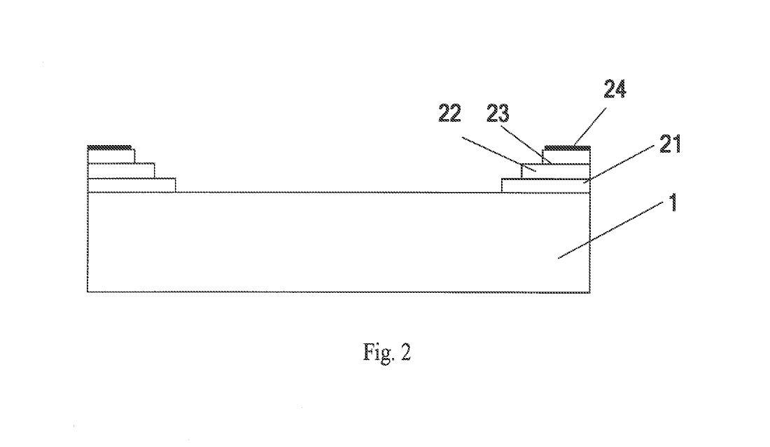

As shown in FIG. 1 and FIG. 2, FIG. 1 is a plan view of a touch screen panel provided by an embodiment of the present invention; FIG. 2 is a sectional view of the touch screen panel taken along line A-A in FIG. 1.

An embodiment of the present invention provides a touch screen panel, the touch screen panel may comprise a substrate 1 and a light blocking frame 2 arranged on the substrate 1 and located in the non-display area of the touch screen, wherein the light blocking frame 2 may comprise at least two layers of step structure convenient for metal wire climbing.

In the above embodiment, the climbing height of the metal wire is reduced as the height of the step by using the light blocking frame 2 with the step structure, which reduces the climbing difficulty of the metal wire, avoids the metal wire from being broken due to over high of the light blocking frame 2, and improves security of the metal wire setting. Meanwhile, the above step structure is used such that the light blocking frame 2 can be fabricated using white photoresist material. Thus, a white touch screen panel product of OGS is realized.

For the convenience of understanding the structure of the touch screen panel provided by the embodiment of the present invention, the touch screen panel provided by the embodiment of the present invention will be described in detail in conjunction with FIG. 1 and FIG. 2 in the following.

Wherein the substrate 1 may be a substrate of different materials, for example, the substrate 1 may be a tempered glass.

Wherein, the light blocking frame 2 comprises at least one white photoresist layer and a black photoresist layer 24 arranged successively along a direction away from the substrate 1, and the widths of the at least one white photoresist layer and the black photoresist layer 24 decrease successively along the direction away from the substrate 1 so as to form the step structure. The thickness of the at least one white photoresist layer may be about 15 μm, the thickness of the black photoresist layer 24 may be between 1˜2 μm, so as to ensure that the whole light blocking frame 2 can have a good light blocking effect.

In a specific setting, the white photoresist layers and the black photoresist layer decrease gradually in width along the direction away from the substrate 1, thereby forming a step structure for metal wire climbing at the side of the light blocking frame facing the display area of the substrate 1. In specific setting of the metal wire, the metal wire is formed on the step structure, since the height of each step is relatively low, thereby avoiding the metal wire from being broken due to over high of the climbing height in the setting of the metal wire, so as to facilitate setting of the metal wire.

In an embodiment, the number of the white photoresist layers may be three, as shown in FIG. 1 and FIG. 2, the three white photoresist layers along the direction away from the substrate 1 are a first white photoresist layer 21, a second white photoresist layer 22 and a third white photoresist layer 23 respectively, from FIG. 2 it can be seen apparently that the widths of adjacent white photoresist layers decrease successively along the direction away from the substrate 1 so as to form steps. Moreover, the thickness of each white photoresist layer may be between 4˜5 μm, the amount by which the widths of the white photoresist layers decrease gradually may be between 60-100 μm. Wherein, the thickness of each white photoresist layer may be 4 μm, 4.2 μm, 4.4 μm, 4.6 μm, 4.8 μm or 5 μm. The amount by which each white photoresist layer decreases in width compared with its adjacent white photoresist layer may be between 60-100 μm, specifically, the decreased size of the width may be 60 μm, 70 μm, 80 μm, 90 μm or any size between 60-100 μm. In an embodiment, the thickness of the white photoresist layer is 5 μm, the amount by which the widths of the white photoresist layers decrease gradually is 80 μm.

When forming the white photoresist layers specifically, white ink material may be used, i.e. the white photoresist layers may be photoresist layers formed by white ink.

In addition, the thickness of the black photoresist layer 24 therein may be between 1˜2 μm, the amount by which the width of the black photoresist layer 24 decreases compared with the width of its adjacent white photoresist layer may be between 20˜40 μm. Specifically, the thickness of the black photoresist layer 24 may be a thickness between 1˜2 μm, such as 1 μm, 1.4 μm, 1.6 μm, 1.8 μm or 2 μm. The amount by which the width of the black photoresist layer 24 decreases compared with the width of its adjacent white photoresist layer may be any size between 20˜40 μm such as 20 μm, 25 μm, 30 μm, 35 μm or 40 μm. In an embodiment, the thickness of the black photoresist layer 24 is 1 μm, the amount by which the width of the black photoresist layer 24 decreases compared with the width of its adjacent white photoresist layer is 20 μm.

In specific preparation of the above light blocking frame 2, it may be realized by the following steps.

Step I: coating a first white photoresist layer 21 on the surface of a tempered glass firstly, the thickness being approximately 4-5 μm, for example, a thickness of 5 μm may be selected.

Step II: coating a second white photoresist layer 22 on the first white photoresist layer 21, the thickness of the second white photoresist layer 22 is approximately 4-5 μm, for example, a thickness of 5 μm may be selected; moreover, the second white photoresist layer 22 is narrowed for a distance of 60-100 μm relative to the first white photoresist layer 21 from the position where the first white photoresist layer 21 borders the visible area, for example, a distance about 80 μm may be selected.

Step III: coating a third white photoresist layer 23 on the second white photoresist layer 22, the thickness of the third white photoresist layer 23 is approximately 4-5 μm, for example, a thickness of 5 μm may be selected; moreover, the third photoresist layer 23 is narrowed for a distance of 60-100 μm relative to the second white photoresist layer 22 from the position where the second white photoresist layer 22 borders the first white photoresist layer 21, for example, a distance about 80 μm may be selected.

Step IV: coating a fourth layer of black photoresist on the third white photoresist layer 23, the thickness of the fourth layer of black photoresist is approximately 1-2 μm, for example, a thickness of 1 μm may be selected; moreover, the fourth layer of black photoresist is narrowed for a distance of 20-40 μm from the position where the third white photoresist layer 23 borders the second white photoresist layer 22, for example, a distance of 20 μm may be selected.

From the above description, it can be seen that the present invention may ensure that the OGS touch screen produced by using the white photoresist layers can achieve the same light shading characteristic and optical appearance effect as the touch screen comprising cover board glass produced by using white ink, meanwhile, the ITO or metal climbing can be realized as a step structure, such as the one of 5/5/5/1 μm as shown in FIG. 1 and FIG. 2, the ITO or metal climbing difficulty is reduced, thereby reducing probability of the occurrence that the ITO or metal climbing is broken, and improving feasibility of ITO or metal climbing.

The embodiment of the present invention further provides a touch screen, the touch screen may comprise any of the touch screen panels as stated above.

In the above embodiment, the climbing height of the metal wire is reduced as the height of the step by using the light blocking frame 2 with the step structure, which reduces the climbing difficulty of the metal wire, avoids the metal wire from being broken due to over high of the light blocking frame 2, and improves security of the metal wire setting. Meanwhile, the above step structure is used such that the light blocking frame 2 can be fabricated using white photoresist material. Thus, a white touch screen product of OGS is realized.

The embodiment of the present invention further provides a display device, the display device may comprises above touch screen.

In the above embodiment, the climbing height of the metal wire is reduced as the height of the step by using the light blocking frame 2 with the step structure, which reduces the climbing difficulty of the metal wire, avoids the metal wire from being broken due to over high of the light blocking frame 2, and improves security of the metal wire setting. Meanwhile, the above step structure is used such that the light blocking frame 2 can be fabricated using white photoresist material. Thus, a white display device product of OGS is realized.

Wherein the display device may be a display, a mobile phone, a television, a laptop, an integrated computer etc., other essential composition parts of the display device all should be understood by the ordinary skilled person in the art, which will not be repeated here, and should not be taken as limitations to the present invention either.

Apparently, the skilled person in the art can make various modifications and variants to the present invention while not departing from the spirit and scope of the present invention. Thus, if these modifications and variants of the present invention fall within the scopes of the claims of the present invention and its equivalent technologies, the present invention also intends to cover these modifications and variants.

1. A touch screen panel comprising:
a substrate; and
a light blocking frame arranged on the substrate and located in a non-display area of the touch screen;
wherein the light blocking frame comprises at least two layers of a step structure convenient for metal wire climbing.

2. The touch screen panel of claim 1, wherein the light blocking frame comprises at least one white photoresist layer and a black photoresist layer arranged successively along a direction away from the substrate, and wherein the widths of the at least one white photoresist layer and the black photoresist layer decrease successively along the direction away from the substrate so as to form the step structure.

3. The touch screen panel of claim 2, wherein the light blocking frame comprises three white photoresist layers, and wherein adjacent white photoresist layers decrease gradually in width along the direction away from the substrate.

4. The touch screen panel of claim 3, wherein the thickness of each of the white photoresist layers is between about 4-5 μm, and the amount by which each white photoresist layer decreases gradually in width compared with its adjacent white photoresist layer is between about 60-100 μm.

5. The touch screen panel of claim 4, wherein the thickness of each of the white photoresist layers is 5 μm, and the amount by which each white photoresist layer decreases gradually in width compared with its adjacent white photoresist layer is about 80 μm.

6. The touch screen panel of claim 2, wherein the white photoresist layers are photoresist layers formed by white ink.

7. The touch screen panel of claim 6, wherein the thickness of the black photoresist layer is between about 1-2 μm, and the amount by which the width of the black photoresist layer decreases compared with the width of its adjacent white photoresist layer is between about 20-40 μm.

8. The touch screen panel of claim 7, wherein the thickness of the black photoresist layer is about 1 μm, and the amount by which of the width of the black photoresist layer decreases compared with the width of its adjacent white photoresist layer is about 20 μm.

9. A touch screen comprising:
a touch surface; and
a touch screen panel comprising:
a substrate; and
a light blocking frame arranged on the substrate and located in a non-display area of the touch screen;
wherein the light blocking frame comprises at least two layers of a step structure convenient for metal wire climbing.

10. A display device comprising:
a display;
a touch screen comprising a touch screen panel having:
a substrate; and
a light blocking frame arranged on the substrate and located in a non-display area of the touch screen;
wherein the light blocking frame comprises at least two layers of step structure convenient for metal wire climbing.
